(19) United States
(12) Patent Application Publication
(10) Pub. No.: US 2025/0137697 A1
(43) Pub. Date: May 1, 2025

(54) FLAME TUBE EXCHANGER FOR ABSORPTION HEAT PUMPS

(71) Applicant: ARISTON S.P.A., Fabriano (IT)

(72) Inventors: Pietro BREVI, Bagnatica (IT); Filippo BONGINI, Bergamo (IT); Giordano TADDEI, Castelplanio (IT); Alessandro CIANFORLINI, Ancona (IT)

(21) Appl. No.: 18/681,801

(22) PCT Filed: Aug. 4, 2022
(86) PCT No.: PCT/IB2022/057240

§ 371 Date: Feb. 6, 2024

(30) Foreign Application Priority Data
Aug. 9, 2021 (IT) 102021000021524

(51) Int. Cl. F25B 39/02; F28D 7/10

(52) U.S. Cl. CPC F25B 39/02; F28D 7/10

(57) ABSTRACT

The object of the invention is a flame tube exchanger for absorption heat pump generators, comprising a first tubular body coaxially inserted in a second tubular body, each tubular body being provided with an inner surface and an outer surface which extend about a common axis, in which the outer surface of the first tubular body is adapted to come into contact with a heating fluid transiting between the first tubular body and the second tubular body from an inlet section to an outlet section, and the outer surface of the second tubular body is adapted to come into contact with a mixture containing a refrigerant to be evaporated by effect of the heat exchanged between the heating fluid and said mixture. The exchanger comprises fins arranged between the outer surface of the first tubular body and the inner surface of the second tubular body to allow both the heat exchange by convection between heating fluid and the tubular surfaces and the surfaces of the finned pack and the thermal conduction of heat between the first tubular body and the second tubular body.

### FIELD OF THE INVENTION

The present invention relates to the technical field of absorption heat pumps. In further detail, the present invention relates to the technical field of flame tube exchangers used for evaporating mixtures containing refrigerants, in general water-ammonia or water-lithium bromide, in generators for absorption heat pumps.

### BACKGROUND ART

Absorption heat pumps are based on a thermodynamic cycle in which the refrigerant, in general water-ammonia (NH₃) or water-lithium bromide (LiBr), passes from the high pressure environment (condenser) to the low pressure environment (evaporator) through an expansion or throttling stage to then return, after an absorption process, to the high pressure stage by means of a pump rather than by means of a compressor, as in the vapor compression thermodynamic cycle (conventional). In this type of plants, indeed, the vapor outlet from the evaporator is absorbed in a liquid solution, pumped, brought to the vapor phase, and then separated from the solution before starting a new cycle.

Condenser and evaporator are conventional components consisting of tubes placed in contact with the service fluids (they can be water or air in the ammonia absorption heat pump) in which the refrigerant flows, yielding heat to the condenser (on the high temperature side) and removing it from the evaporator (on the low temperature side).

The absorption occurs in an exchanger called absorber and is promoted by the removal of heat. The lower the temperature reached, the smaller the amount of solution required to absorb the cooling vapor.

The separation of the liquid solution occurs in a generator by introducing heat. Since the released vapors do not exclusively consist of refrigerant vapors, a rectifier is generally present between the generator and the condenser to ensure a certain purity of the refrigerant.

The transformations the refrigerant is subjected to form the cycle of the absorption heat pump. The energy required for operation is supplied by the generator, in particular by a burner, conventionally a gas burner, which heats the refrigerant-enriched solution by means of a flame tube. A small amount of electricity is then required to drive the pump.

The presence of refrigerants such as ammonia requires the heat pump circuit to be made of steel since the metals containing aluminum, copper or zinc cannot be used due to the corrosion to which they would be subjected. Therefore, since the circuit containing the refrigerant is to be sealed from the environment, the construction thereof requires welding made with different technology and various and more costly apparatuses than the more common brazing joints used in vapor compression machines utilizing fluorinated gases.

This aspect is particularly critical in the generator where the pressure is rather high (even greater than 20 bar) and where it is ensured that the pressurized ammonia vapor which is accidentally released does not come into direct contact with the discharge fumes or with the burner flame.

As known, flame tubes comprise one or more tubes inside which the hot fumes originating from a burner transit. By introducing such tubes into a container filled with the liquid to be heated, the heat of the fumes is transmitted to the walls of the tubes and therefore to the liquid being heated up to evaporation.

A possible sealing defect of the flame tube may therefore result in various negative effects, starting with the leaking of refrigerant (in the case of ammonia, the refrigerant is toxic at a high temperature and high pressure), which in turn could stop the group.

The object of the present invention is to provide a flame tube exchanger capable of safely and efficiently bringing mixtures containing pressurized refrigerants in absorption heat pump generators to the boiling point and then evaporating them.

### BRIEF DESCRIPTION OF THE INVENTION

The present invention achieves the object with a flame tube exchanger for absorption heat pump generators, comprising a first tubular body coaxially inserted in a second tubular body, each tubular body being provided with an inner surface and an outer surface which extend about a common axis, in which the outer surface of the first tubular body is adapted to come into contact with a heating fluid transiting between the two tubular bodies from an inlet section to an outlet section, and the outer surface of the second tubular body is adapted to come into contact with a mixture containing a refrigerant to be evaporated by effect of the heat exchanged between the heating fluid and said mixture.

The exchanger comprises fins arranged between the outer surface of the first tubular body and the inner surface of the second tubular body to first allow the heat exchange and then the thermal conduction of heat towards the second tubular body.

By using this configuration, the flow of the ammonia-enriched mixture is separated from the flow of heating fluid on the wall of the second tubular body, which ensures that the two fluids may come into contact only following a breaking of the exchanger itself. The adequate level of heat exchange is ensured by the presence of joining fins between the two tubes which allow a thermal transmission first by convection and successively by conduction towards the outer tubular body.

The fins may be in varying number, shape and length so as to allow the maximum assembly flexibility to accommodate the most varied needs in terms of volume, power density, exchange gradient along the tubular axis, load losses of the heating fluid and heat exchange efficiency.

A second aspect of the invention relates to a process for making a flame tube exchanger for absorption heat pumps, comprising the following steps:
obtaining a first tubular body;
obtaining a second tubular body;
obtaining metal fins;
coating the metal fins with a layer of brazing material;
positioning the fins and the first tubular body inside the second tubular body;
pressing the first tubular body against the fins and the inner surface of the second tubular body;
brazing the fins on the first tubular body and on the second tubular body.

The further features and improvements are the subject of the sub-claims.

### BRIEF DESCRIPTION OF THE DRAWINGS

Further features and advantages of the invention will become apparent from the reading of the following detailed description, given by way of a non-limiting example, with the aid of the figures shown on the accompanying drawings, in which:

FIG. 1 diagrammatically shows the components of an absorption heat pump.

FIG. 2 diagrammatically shows the pressures and temperatures in an absorption cycle.

FIG. 3 shows a flame tube exchanger according to an embodiment of the invention.

FIG. 4 shows a generator for absorption heat pumps comprising the exchanger of FIG. 3.

FIG. 5 shows a flow diagram of a process for providing a flame tube exchanger according to the invention.

The following description of exemplary embodiments relates to the accompanying drawings. The same reference numbers in the various drawings identify the same elements or similar elements. The following detailed description does not limit the invention. The scope of the invention is defined by the appended claims.

### DETAILED DESCRIPTION OF THE INVENTION

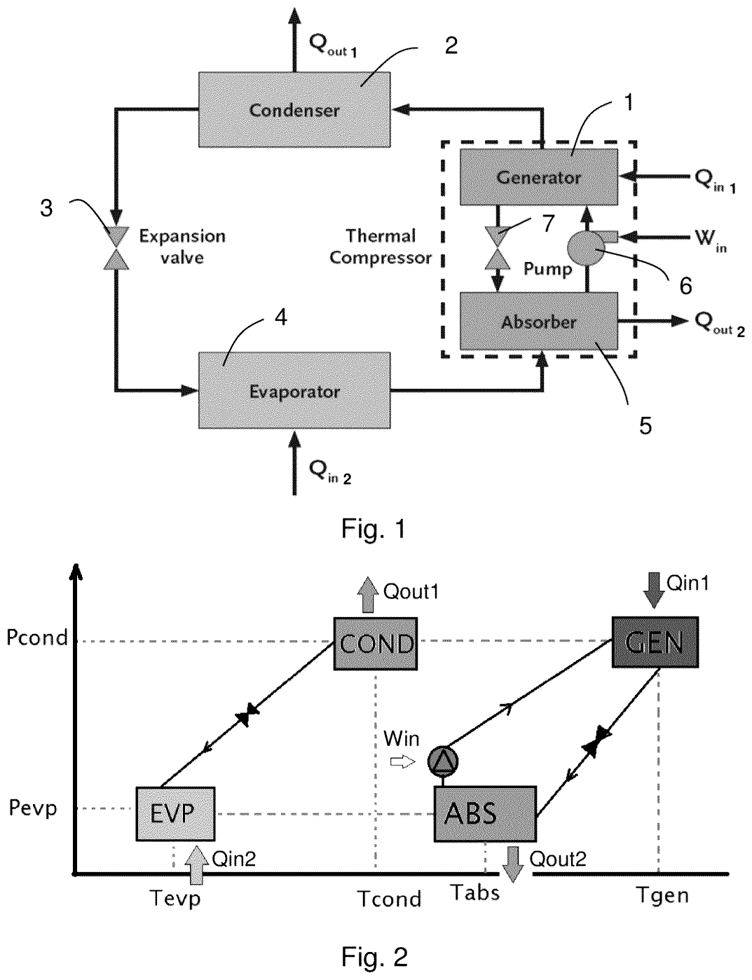

With reference to FIG. 1, an absorption heat pump comprises a generator 1, a condenser 2, a first expansion valve 3, an evaporator 4, an absorber 5, a pump 6, and a second expansion valve 7.

The fluid evolving in the machine is a mixture containing a cooling substance, for example ammonia in water. By effect of an amount of heat Qin1 which is supplied to generator 1, for example by means of a gas burner, the refrigerant, being the most volatile component of the mixture, separates from the solution. The vapor thus generated is sent to condenser 2, where it condenses, thus yielding heat Qout1 to an external source. Generator 1 and condenser 2 are both at a pressure Pcond which depends on the condensation temperature Tcond.

The refrigerant is then brought to a lower pressure Pevap by means of an expansion valve 3 and then sent to evaporator 4 in which it evaporates, removing heat Qin2 from an external source.

For the cycle to be repeated, the refrigerant needs to be brought back to a solution. Such a task is assigned to absorber 5 in which the vapor of the low temperature refrigerant Tevp from evaporator 4 and the solution from generator 1 brought back to low pressure by an expansion valve 7 meet. Heat Qout2 also needs to be removed from absorber 5 to allow the condensation of the refrigerant and the dilution of the solution. The solution thus enriched is brought to a high pressure Pcond by pump 6 to be introduced into generator 1 again, where it starts its cycle again. Pump 6 absorbs electricity (indicated by Win in the drawing).

FIG. 2 diagrammatically shows the pressures and temperatures involved in an absorption cycle like that described above indicating the energies exchanged by means of arrows.

Overall, the energy balance is as follows:

$${Q}_{o u t 1} + {Q}_{o u t 2} = {Q}_{in 1} + {Q}_{in 2} + {W}_{i n} \to {Q}_{C O N D} + {Q}_{A S S O R B} = {Q}_{G E N} + {Q}_{E V A P} + {W}_{P O M P A}$$

$$\begin{matrix}[ “ ASSORB ” = ABSORB \\ “ POMPA ” = PUMP ]\end{matrix}$$

While the heating and cooling efficiencies are given by:

$${η}_{C O O L} = \frac{{Q}_{i n 2}}{{Q}_{i n 1} + {W}_{i n}} = \frac{{Q}_{E V A P}}{{Q}_{G E N} + {W}_{P O M P A}}$$

$${η}_{H E A T} = \frac{{Q}_{o u t 1} + {Q}_{o u t 2}}{{Q}_{i n 1} + {W}_{i n}} = \frac{{Q}_{C O N D} + {Q}_{A S S O R B}}{{Q}_{G E N} + {W}_{P O M P A}} = \frac{{Q}_{G E N} + {Q}_{E V A P} + {W}_{P O M P A}}{{Q}_{G E N} + {W}_{P O M P A}} = 1 + \frac{{Q}_{E V A P}}{{Q}_{G E N} + {W}_{P O M P A}}$$

$$\begin{matrix}[ “ ASSORB ” = ABSORB \\ “ POMPA ” = PUMP \\ “ EVAP ” = EVAP ]\end{matrix}$$

Several variants are possible starting from the base diagram shown in FIG. 1, mostly aiming to optimize the thermal exchanges and therefore increase the efficiencies, for example by using recuperative exchangers.

With regards to generator 1, this conventionally comprises a container adapted to collect the refrigerant-enriched solution to be separated into its components, and a flame tube exchanger adapted to heat the solution up to bringing the low-boiling component to evaporation, i.e., the ammonia in the case of circuits based on solutions having water as solvent and ammonia as solute.

The flame tube exchanger comprises one or more tubes inside which the hot fumes originating from a burner transit. The invention relates to an improvement of the known flame tube exchangers.

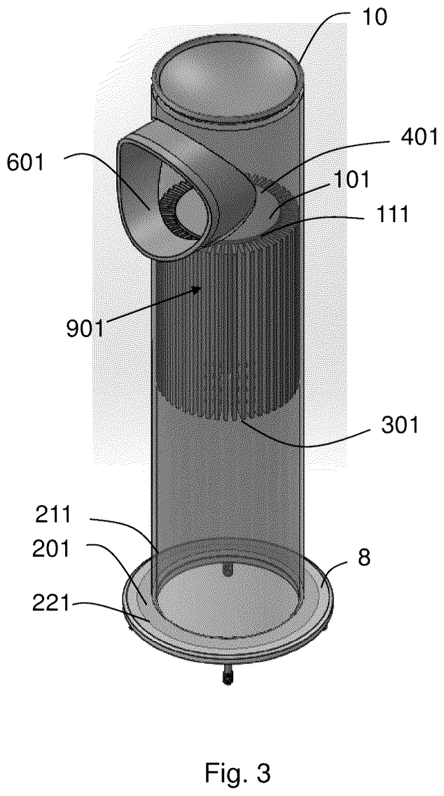

FIG. 3 shows a flame tube exchanger 10 according to an embodiment of the present invention. The exchanger is of the tube in tube type, i.e., it comprises a first tubular body 101 coaxially inserted in a second tubular body 201.

Each tubular body, conventionally made of steel, stainless steel, is provided with an inner surface and an outer surface which develop about a common axis. FIG. 3 shows the inner surface 211 alone of the second tubular body 201, while the outer surface 221 and the thickness between inner surface and outer surface of the same tubular body 201 are left in transparency to simplify the graphical depiction thereof.

The outer surface 111 of the first tubular body 101 and the inner surface 211 of the second tubular body 201 are put into contact with a heating fluid transiting in the interspace between first and second tubular body from an inlet section 301 to an outlet section 401, while the outer surface 221 of the second tubular body 201 is put into contact with solution 8 containing the refrigerant to be evaporated by effect of the heat exchanged between the heating fluid and the solution.

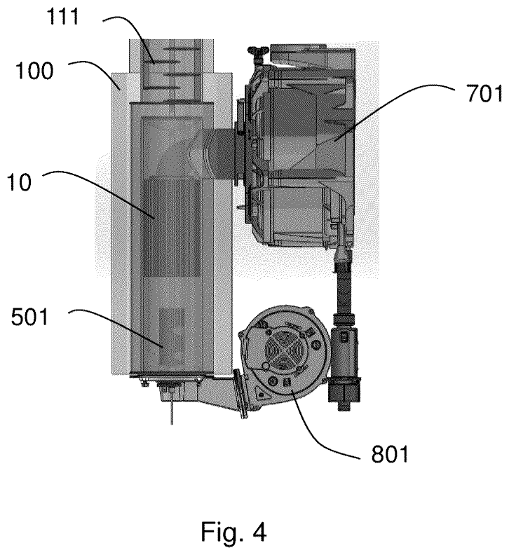

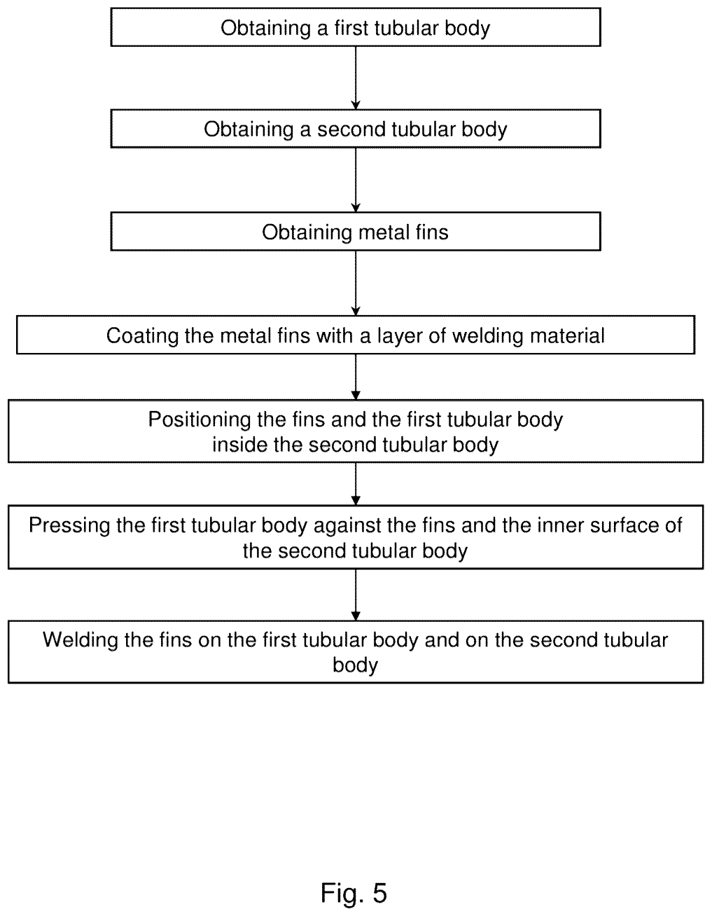

The inlet section 301 of the heating fluid is coupled with a burner 501 (shown in FIG. 4) so that the fumes generated by the combustion form the heating fluid which transits in the interspace between the first tubular body 101, from the inlet section 301 to the outlet section 401, and the second tubular body 201, lapping the finned surfaces 901, which are discussed in detail below.

In order to direct the outlet fumes outwards, the outlet section 401 of the first tubular body 101 may be coupled with an outlet sleeve 601 associated with an opening made in the second tubular body 201, for example, at 90° with respect to the axis of the tubular body, as shown in FIG. 3. In the configuration shown in FIG. 4, the fumes are directed towards an exchanger 701 for possible heat recovery so as to further increase the performance of the cycle, and burner 501 is fed by a combustion train 801 according to the teachings known to a skilled expert.

The first tubular body 101 conventionally has a smaller longitudinal extension than the one of the second tubular body 201 so as to only occupy a part of the entire lumen of the second tubular body 201, as shown in FIG. 3. In this case, the fumes entering the exchanger 10 travel along a first stretch of the second tubular body 201 alone to then involve both tubular bodies 101, 201 prior to exiting from the outlet sleeve 601.

Since one or both the inlet/outlet sections of the first tubular body 101 conventionally are closed (potentially, the tubular body 101 could also be made by means of a solid cylinder), the fumes cross only the interspace between the two tubular bodies. However, the possibility is not excluded for part of the fumes to also flow in the first tubular body 101, thus contributing to heating the walls thereof.

The main function of the inner tubular body 101 is mainly that of keeping in position the fins during the embodiment process and guiding the outflow of fumes, forcing them to flow, and therefore exchange heat, into the finned pack.

The flame tube exchanger 10 may be inserted in a container 100 of any shape. In an embodiment, such a container has a tubular structure which encloses the first 101 and the second 201 tubular body so that the mixture containing refrigerant 8 is confined outside the outer surface of the second tubular body 201.

Container 100 advantageously may also enclose burner 501, thus obtaining a highly compact structure.

Fins 901 are present, conventionally metallic fins, arranged between the outer surface of the first tubular body 101 and the inner surface of the second tubular body 201, to allow increasing the exchange surface by convection with the heating fluid and thermal conduction of heat between first tubular body 101 and second tubular body 201.

The fins 901, which may have any shape, length, height and thickness, have extending surfaces, for example having rectangular or trapezoidal cross section, which project from the outer surface 111 of the first tubular body 101 to the inner surface 211 of the second tubular body 201, substantially in radial direction and for substantially the entire length of the first tubular body 101 to form longitudinal ribs with interspaces between the facing extended surfaces.

In the simplest case shown in the drawings, the fins 901 are arranged parallel to the axis of the tubular bodies. More complex configurations may exist, in which there are several groups of differently oriented fins. The fins may, for example, be spirally wound according to a given angle which varies according to the heat exchange to be achieved.

The fins are provided in varying shape, number and length so as to allow assembly flexibility to accommodate the most varied needs in terms of heat exchange volume and efficiency.

The fins may be formed together with one of the two tubular bodies, for example by molding or extrusion, to then be welded to the other tubular body, or they may constitute separate components obtained for example, by molding, laser cutting or 3D printing, which first are positioned between the two tubular bodies to then be welded.

A process for making a flame tube exchanger according to the invention may, for example, comprise the following steps:
coating the metal fins with a layer of brazing material, for example, by electrocoating;
positioning the fins and the first tubular body inside the second tubular body;
pressing the first tubular body against the fins and the inner surface of the second tubular body, for example with a hydroforming process;
brazing the fins on the first tubular body and on the second tubular body, for example, by brazing with heat the exchanger up to obtaining the melting of the welding material to decrease the thermal resistance at the contact points.

The sub-assembly formed by first tubular body, fins and second tubular body is then inserted into a container, conventionally a tubular container, leaving an interspace between inner wall of the container and outer wall of the second tubular body. Thereby, a highly compact flame tube exchanger with a reduced number of welds and increased heat exchange adjustable by acting on the features and number of fins, is provided.

By virtue of the advantageous use of a finned configuration, the exchanger allows increased exchange density by conduction to be achieved on the outer tubular body. This allows having an exchanger which can be designed with broad degrees of freedom, increased safety levels and reliability (thickness of the outer tubular body not restrained and absence of welds on the wall of the outer tubular body) and with an increased possibility of industrialization with subsequent advantages in terms of processing costs and complexities.

The flame tube exchanger 10 according to the invention may constitute the entire generator 1 of the absorption heat pump or part thereof. In certain configurations, a distilling column, for example, a plate distilling column 111, may be over the exchanger in fluid-dynamic communication to receive the outlet solution in vapor phase, as shown in the upper part of FIG. 4. Thereby, a kind of fractioned distillation occurs which enriches the vapor of the low-boiling fluid, i.e., the refrigerant, which makes the plant even more efficient.

1. A process for making a flame tube exchanger for absorption heat pumps, comprising the following steps:
-obtaining a first tubular body;
obtaining a second tubular body;
obtaining metal fins;
coating the metal fins with a layer of brazing material;
positioning the fins and the first tubular body inside the second tubular body;
pressing the first tubular body against the fins and the inner surface of the second tubular body;
heating the fins on the first tubular body and on the second tubular body, wherein the pressing of the first tubular body on the fins and on the second tubular body is made by hydroforming.

2. The process according to claim 1, wherein coating the fins with the welding material occurs by electrocoating.

3. The process according to claim 1, wherein the step of welding the fins on the first tubular body and on the second tubular body occurs by brazing by heating the exchanger up to obtaining the melting of the welding material.

4. The process according to claim 1, wherein the step of coating with material by brazing occurs after the positioning of the fins between the first tubular body and the second tubular body, prior to brazing by heating the exchanger up to obtaining the melting of the brazing material.

5. The process according to claim 1, wherein the fins are obtained by molding, laser cutting or 3D printing.

6. The process according to claim 1, wherein the fins are obtained in varying shape, number and length so as to allow assembly flexibility to accommodate the most varied needs in terms of heat exchange volume and efficiency of the exchanger.

7. The process according to claim 1, wherein the step is provided of inserting the sub-assembly formed by first tubular body, fins and second tubular body into a container, conventionally a tubular container, leaving an interspace between inner wall of the container and outer wall of the second tubular body.

8. A flame tube exchanger for absorption heat pump generators, comprising a first tubular body coaxially inserted in a second tubular body, each tubular body being provided with an inner surface and an outer surface which extend about a common axis, characterized in that the outer surface of the first tubular body is adapted to come into contact with a heating fluid transiting between the two tubular bodies from an inlet section to an outlet section, and the outer surface of the second tubular body is adapted to come into contact with a mixture containing a refrigerant to be evaporated by effect of the heat exchanged between the heating fluid and said mixture, wherein the exchanger further comprises fins arranged between the outer surface of the first tubular body and the inner surface of the second tubular body to allow thermal conduction of heat between the first tubular body and the second tubular body and increase the convection heat exchange surface with the heating fluid wherein the flame tube exchanger is made through the process according to claims 1 to 7.

9. An exchanger according to claim 8, wherein the first tubular body has a smaller longitudinal extension than the one of the second tubular body so as to only occupy a part of the inside lumen of the second tubular body.

10. The exchanger according to claim 8, wherein the first tubular body is closed at at least one end so that the heating fluid may exclusively transit in the interspace between the outer surface of the first tubular body and the inner surface of the second tubular body.

11. The exchanger according to claim 8, wherein the fins have extending surfaces which project from the outer surface of the first tubular body to the inner surface of the second tubular body, substantially in radial direction and for substantially the entire length of the first tubular body to form longitudinal ribs with gaps between the facing extended surfaces.

12. The exchanger according to claim 8, wherein the fins are rectangular or trapezoidal in shape.

13. The exchanger according to claim 8, wherein the inlet section of the heating fluid is coupled with a burner so that the fumes generated by the combustion form the heating fluid which transits in the interspace between the first and the second tubular body from the inlet section to the outlet section.

14. The exchanger according to claim 8, characterized in that it comprises comprising a third tubular body which encloses the first and the second tubular body so that the mixture containing the refrigerant is confined between the inner surface of the third tubular body and outer surface of the second tubular body.

15. The exchanger according to claim 14, wherein the third tubular body also encloses the burner.

16. The exchanger according to claim 8, wherein the first tubular body is made from a solid cylinder.

17. A generator for absorption heat pumps comprising a container adapted to collect a solution enriched with refrigerant to be separated into its components, a flame tube exchanger according to claim 8 arranged in the container so that the outer surface of the second tubular body is in contact with the solution, a burner with fume discharge fluid-dynamically connected to the inlet section defined in the finned interspace between the first tubular body and the second tubular body of the flame tube exchanger, and a plate distillation column in fluid-dynamic communication with the container to receive the solution in vapor step outlet from the container.
